(19) United States
(12) Patent Application Publication
(10) Pub. No.: US 2014/0071788 A1
(43) Pub. Date: Mar. 13, 2014

(54) MIXING IMPELLER HAVING CHANNEL-SHAPED VANES

(71) Applicant: Li Wang, (US)

(72) Inventors: Li Wang, Coquitlam, CA (US); Tianzhi Wang, Coquitlam (CA)

(73) Assignee: Li Wang, Coquitlam (CA)

(21) Appl. No.: 14/080,991

(22) Filed: Nov. 15, 2013

Related U.S. Application Data
(63) Continuation-in-part of application No. 13/304,368, filed on Nov. 24, 2011.

(51) Int. Cl. B01F 7/00

(52) U.S. Cl. CPC B01F 7/00016
USPC 366/279; 366/343

(57) ABSTRACT

The present invention relates to a mixing impeller for an agitator. The impeller has a body that may be disc-shape. The impeller has a plurality of circumferentially spaced-apart, longitudinally curved, channel-shaped outer vanes connected to and extending outwards from the body in a plurality of different directions. A first one of the outer vanes has a distal end at least partially facing above the body. A second one of the outer vanes has a distal end at least partially facing below the body. A third one of the outer vanes has a distal end at least partially facing tangential to the body.

### FIELD OF THE INVENTION

The present invention relates to a mixing impeller. In particular, the invention relates to a mixing impeller having longitudinally curved, channel-shaped vanes.

### DESCRIPTION OF THE RELATED ART

U.S. Pat. No. 5,791,780 to Bakker shows an impeller assembly for agitating a fluid contained in a vessel and dispersing a gas introduced therein. The impeller assembly includes an impeller having a plurality of generally radially extending blades. Each of the blades includes diverging upper and lower sheet-like portions having generally radially extending leading edges. The upper and lower portions are joined to form a generally V-shaped cross-section with a trailing vertex. The width of the upper portion of each blade is greater than the width of the lower portion of the blade such that the upper portion leading edge extends forwardly of the lower portion leading edge, thus producing an upper portion overhang to capture and disperse rising gas bubbles. The impeller assembly further comprises a drive assembly for rotating the impeller assembly.

U.S. Pat. No. 5,246,289 to Middleton et al. shows an agitator assembly for use in effecting dispersion of a fluid such as a gas in a liquid. The assembly comprises a rotor having a rotatably driven shaft mounting a series of scoop-shaped blades which are oriented with the mouths of the scoops presented in the direction of rotation of the shaft. Each blade is mounted at an angle of attack such that one end of the blade leads the other in the direction of rotation. To eliminate gas cavity formation, each blade is of a generally streamlined configuration in section and the ends thereof are generally transverse to the axis of rotation of the rotor.

U.S. Pat. No. 5,037,209 to Wyss shows a stirring mechanism, with a plurality of hollow, at least partially conically shaped stifling elements. These elements are provided with two openings, are symmetrically offset and are fixed on the stifling shaft at least approximately tangential to an imaginary circular cylinder coaxial to the stifling shaft. In the starting phase, the stirred substance flows laminarly through the stifling elements. However, as soon as they have reached a predetermined minimum velocity of about 1.3 m/s, the flow inside the stirring elements is forced to reverse by dynamic pressure.

### BRIEF SUMMARY OF INVENTION

The present invention provides, and it is an object of the present invention to provide, an improved mixing impeller.

There is accordingly provided a mixing impeller for an agitator. The impeller has a body. The impeller has a plurality of circumferentially spaced-apart, longitudinally curved, channel-shaped outer vanes connected to and extending outwards from the body in a plurality of different directions.

There is also provided a mixing impeller for an agitator. The impeller has an axis of rotation and includes an annular body having a top and a bottom. The impeller has a plurality of circumferentially spaced-apart, channel-shaped, tapered outer vanes connected to and extending outwards from the top and the bottom of the body. Each of the outer vanes has a proximal end connected to the body and a distal end radially spaced-apart from the proximal end. The distal ends are smaller in cross-section relative to the proximal ends. At least one of the outer vanes is shaped to extend axially outwards relative to the axis of rotation. At least another of the outer vanes is shaped to extend radially outwards. At least a further of the outer vanes is shaped to be at least partially bisected by the body. The distal end of a first one of the outer vanes at least partially faces above the body. The distal end of a second one of the outer vanes at least partially faces below the body. The distal end of a third one of the outer vanes at least partially faces tangential to the body.

### BRIEF DESCRIPTION OF DRAWINGS

The invention will be more readily understood from the following description of preferred embodiments thereof given, by way of example only, with reference to the accompanying drawings, in which:

FIG. 1 is a side elevation view of an agitator assembly, showing a tank in section, a motor and gear box assembly mounted to the tank, and an impeller according to a first aspect, the impeller being connected to the motor;

FIG. 2 is a top perspective view of the impeller shown in FIG. 1;

FIG. 3 is a top plan view of the impeller shown in FIG. 1;

FIG. 4 is a bottom perspective view of the impeller shown in FIG. 1;

FIG. 5 is a side elevation fragmented view of the impeller shown in FIG. 1, with a plurality of outer vanes being shown angularly spaced-apart from the body of the impeller;

FIG. 6 is a top perspective view of an impeller according to a second aspect;

FIG. 7 is a bottom perspective view of the impeller shown in FIG. 6;

FIG. 8 is a top plan view of the impeller shown in FIG. 6;

FIG. 9 is a side elevation view of the impeller shown in FIG. 6;

FIG. 10 is a top perspective view of an impeller according to a third aspect;

FIG. 11 is a bottom perspective view of the impeller shown in FIG. 10;

FIG. 12 is a top plan view of the impeller shown in FIG. 10;

FIG. 13 is a side elevation view of the impeller shown in FIG. 10;

FIG. 14 is a top perspective view of an impeller according to a fourth aspect, together with part of an agitator shaft connected thereto, the impeller having a pair of conical deflectors, only one of which being shown in FIG. 14;

FIG. 15 is an exploded view of the impeller shown in FIG. 14, with one of the deflectors being shown spaced-apart and removed from the rest of the impeller;

FIG. 16 is a side elevation view of the impeller shown in FIG. 14 showing both conical deflectors;

FIG. 17 is a top perspective view of an impeller according to a fifth aspect;

FIG. 18 is a bottom plan view of the impeller shown in FIG. 17;

FIG. 19 is a side elevation view of the impeller shown in FIG. 17;

FIG. 20 is a top perspective view of part of an impeller according to a sixth aspect;

FIG. 21 is a top perspective view of an impeller according to a seventh aspect;

FIG. 22 is an elevation view of the impeller shown in FIG. 21;

FIG. 23 is a top plan view of the impeller shown in FIG. 21;

FIG. 24 is a top plan view of one of the vanes of the impeller shown in FIG. 21;

FIG. 25 is a top, side perspective view of the vane shown in FIG. 24;

FIG. 26 is a side elevation view of the vane shown in FIG. 25;

FIG. 27 is a top perspective view of an impeller according to an eighth aspect;

FIG. 28 is an elevation view of the impeller shown in FIG. 27;

FIG. 29 is a top plan view of the impeller shown in FIG. 27;

FIG. 30 is an elevation view of an impeller according to a ninth aspect;

FIG. 31 is a bottom plan view of the impeller of FIG. 30;

FIG. 32 is a bottom perspective view of the impeller of FIG. 30;

FIG. 33 is a cross-section view of a distal end of a vane for an impeller according to a tenth aspect;

FIG. 34 is a cross-section view of a distal end of a vane for an impeller according to an eleventh aspect;

FIG. 35 is a cross-section view of a distal end of a vane for an impeller according to a twelfth aspect;

FIG. 36 is a cross-section view of a distal end of a vane for an impeller according to a thirteenth aspect; and

FIG. 37 is a cross-section view of a distal end of a vane for an impeller according to a fourteenth aspect.

### DESCRIPTION OF THE PREFERRED EMBODIMENTS

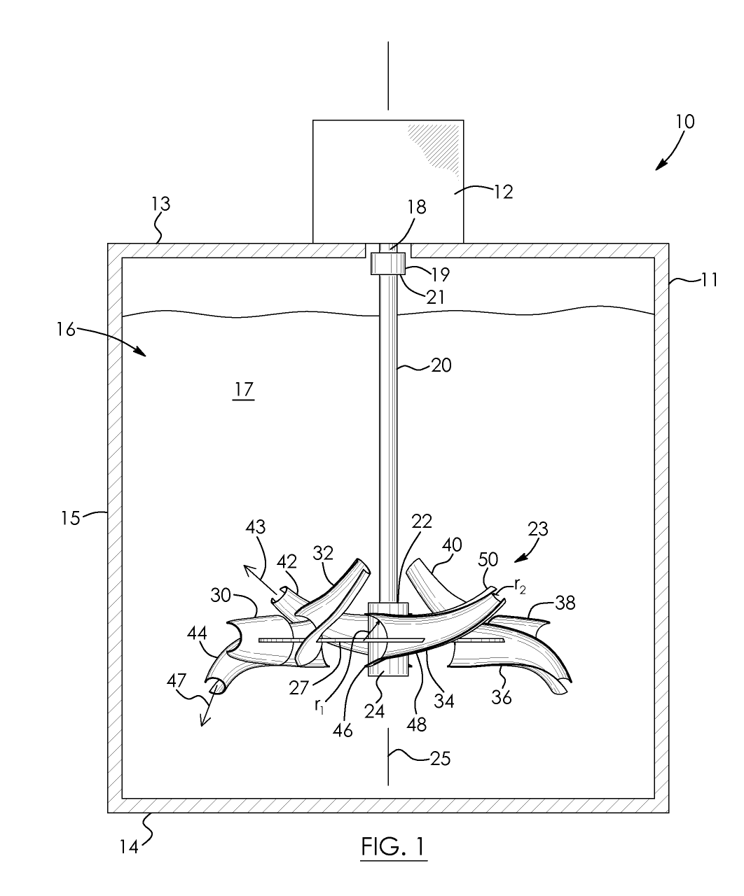

Referring to the drawings and first to FIG. 1, there is shown an agitator assembly 10. The assembly has a housing, in this example a tank 11. The assembly 10 has an actuator, in this example an electric motor and gear box assembly 12 mounted to the tank. The motor and gear box assembly is conventional and well known to those skilled in the art. Its parts and operation per se will therefore not be described in detail. The tank 11 is cylindrically-shaped in this example, and has a top 13, a bottom 14 opposite the top, and a curved, peripheral side 15 in this example extending between the top and bottom. The tank 11 has an interior 16 within which is disposed a substance to be mixed, in this example a liquid 17. In another embodiment, the tank may contain solid materials or a liquid-solid mixture to be mixed. The agitator assembly 10 may be used, for example, in the chemical industry or in a waste management system.

The motor and gear box assembly 12 has a stub shaft 18. The assembly 10 includes a coupling member 19 and an agitator shaft 20. The agitator shaft has a first end 21 and a second end 22 opposite the first end. The coupling member 19 couples the first end of the agitator shaft 20 to the stub shaft 16 of the motor. Shaft 20 is thus rotatably connected to the motor and gear box assembly 12.

The agitator assembly 10 has a mixing impeller 23 mounted to the second end 22 of the shaft 20. The impeller includes a centrally disposed hub 24, in this example. The hub has an aperture 26, best shown in FIG. 3, shaped to receive the second end of the shaft. Referring back to FIG. 1, the shaft 20 may be keyed to the hub 24 for connecting to the hub and shaft together. The impeller 23 has an axis of rotation 25 around which shaft 20 and impeller 23 rotate.

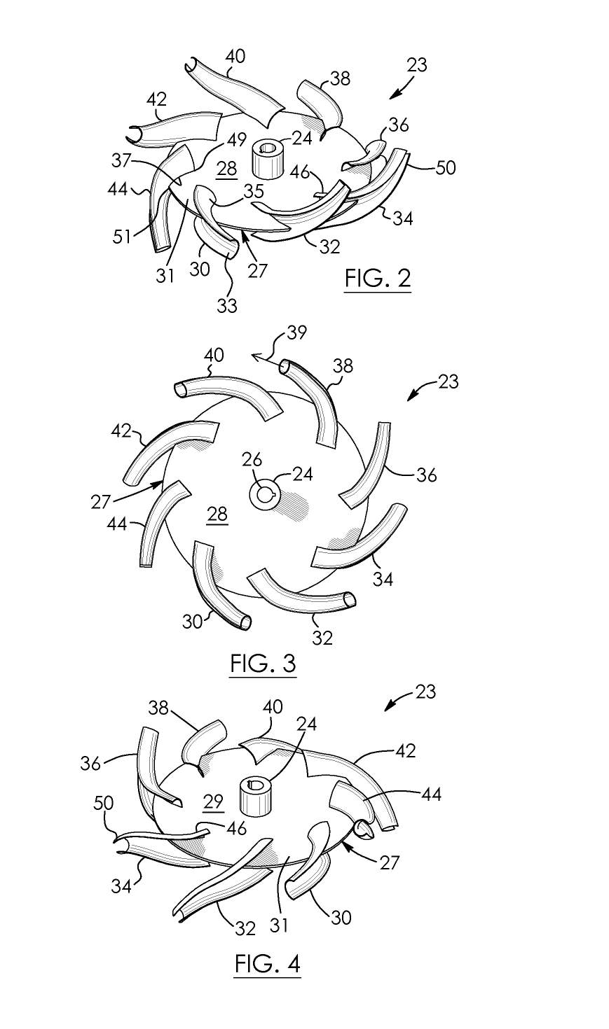

As seen in FIG. 3, the impeller 23 has disc-shaped body 27. The body has a top 28 shown in FIGS. 2 and 3 facing the top 13 of the tank 11 shown in FIG. 1. Referring to FIG. 4, the body 27 has a bottom 29 opposite its top and an outer peripheral portion 31 that is circular in this example. The bottom of the body faces the bottom 14 of the tank shown in FIG. 1.

Referring to FIG. 2, the impeller 23 has a plurality of circumferentially spaced-apart, longitudinally curved, channel-shaped outer vanes 30, 32, 34, 36, 38, 40, 42, and 44. While eight vanes are shown in this example, this number of vanes is not strictly required and there may be a different number of vanes in other embodiments.

The outer vanes 30, 32, 34, 36, 38, 40, 42, and 44 extend outwards from the body 27 in a plurality of different directions. Vanes 30, 32, 34 and 36 are circumferentially spaced-apart by 180 degrees relative to vanes 38, 40, 42 and 44, respectively. The outer vanes 30, 32, 34, 36, 38, 40, 42, and 44 are channel-shaped and c-shaped in section in this example. Each vane has a convex side and a concave side, as shown in FIG. 2 by concave side 33 and convex side 35 for vane 30.

Each of the outer vanes has a proximal end connected to the body. This is shown in FIG. 4 for vane 34 by its proximal end 46. The proximal ends of the outer vanes connect to both the top 28 and the bottom 29 of the body 27, with the body bisecting the proximal ends of the vanes in this example and the vanes disposed through radially extending and circumferentially spaced-apart, curved slots of the body. This is shown by arc-shaped slot 37 for vane 44 in FIG. 2. Each slot has a first end 49 aligning with the proximal end of a respective one of the vanes and a second end 51 which is radially and circumferentially spaced-apart from its first end. The second ends of the slots 37 align with the outer peripheral portion 31 of the body 27, with the slots extending inwards therefrom. Body 27 at least partially intersects with and extends through the proximal ends 46 of the vanes in this example via the slots 37.

Each of the outer vanes tapers towards a distal end which is radially and circumferentially spaced-apart from its proximal end, in this embodiment. This is shown by distal end 50 for vane 34. In this embodiment, the channel-shaped distal ends 50 are smaller in cross-section relative to the channel-shaped proximal ends 46. Each outer vane has a radius of curvature r₁ at the proximal ends 46 of the outer vanes which is greater than the radius of curvature r₂ at the distal ends 50 of the outer vanes in this example.

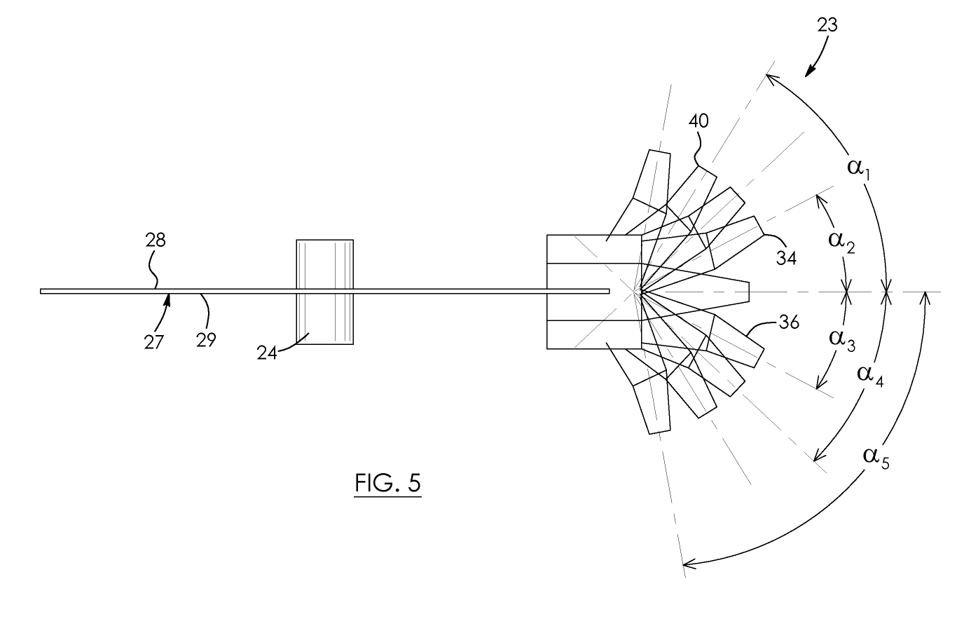

Referring to FIGS. 1 and 2, at least one of the distal ends of the vanes is axially spaced-apart above the body in this example, axially in the direction of axis 25. In this case, outer vanes 32, 34, 40 and 42 are shaped to extend axially outwards from the top 28 of the body 27 relative to the axis of rotation 25 shown in FIG. 1 in this example, axially in the direction of axis 25. These outer vanes also extend radially outwards with their distal ends at least partially facing the top 13 of the tank 11 in this example. These vanes so configured thus promote upward movement of the liquid, as shown by arrow of numeral 43 for vane 42 in FIG. 1. Vanes 32 and 40 extend outwards from the top of the body at a greater angle relative to vanes 34 and 42. In this example, vanes 32 and 40, as shown by vane 40 in FIG. 5, are angularly spaced-apart from the top 28 of the body 27 at an angle α₁ equal to 60 degrees. Vanes 34 and 42 are angularly spaced-apart from the top of the body at an angle α₂ equal to 30 degrees, in this example.

As seen in FIGS. 1 and 4, at least one of the distal ends of the vanes is axially spaced below the body in this example, axially in the direction of axis 25. In this case, outer vanes 36 and 44 are shaped to extend axially outwards from bottom 29 of the body 27 relative to the axis of rotation 25 shown in FIG. 1 in this example, axially in the direction of axis 25. These outer vanes extend radially outwards with their distal ends at least partially facing the bottom 14 of the tank 11 in this example. These vanes so configured promote downward movement of the liquid, as shown by arrow of numeral 47 for vane 44 in FIG. 1. Referring to FIG. 5, these vanes, as shown by vane 36, are angularly spaced-apart from the bottom 29 of the body 27 at an angle α₃ equal to 30 degrees.

Angles α₁, α₂ and α₃ are provided by way of example only. Alternatively, one or more of the outer vanes may be angularly spaced-apart from the body 27, below or above the body, by an angle α₄ equal to 45 degrees or an angle α₅ equal to 80 degrees, for example.

Referring to FIGS. 1 and 2, outer vanes 30 and 38 are shaped to extend radially outwards from the body 27, with their distal ends facing the side 15 of the tank 11. Each of the vanes, with vanes 30 and 38 in particular, are shaped to promote centrifugal movement of the liquid, as shown by arrow of numeral 39 for vane 38 in FIG. 3.

Impeller 23 as herein described, with its channel-shaped, tapered vanes extending in a plurality of directions, may thus enable liquid or other substances within the tank 11 to be mixed in a more enhanced and efficient manner.

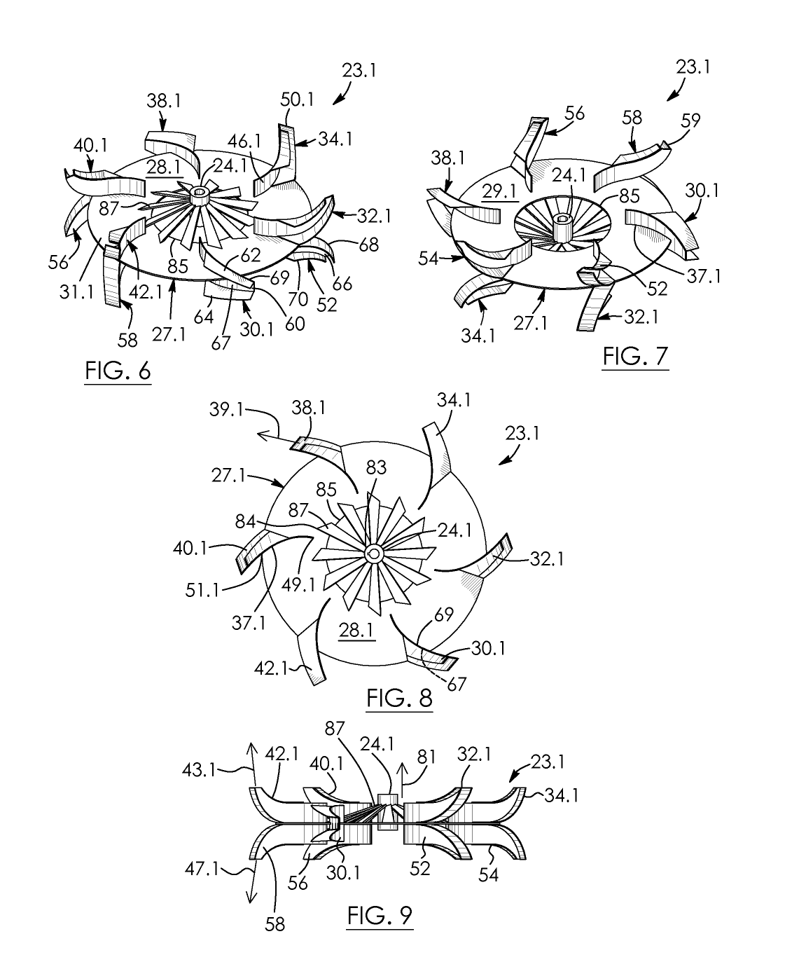

FIGS. 6 to 9 show an impeller 23.1 for the agitator assembly 10 shown in FIGS. 1 to 5 according to a second aspect. Like parts have like numbers and functionings as the embodiment shown in FIGS. 1 to 5 with the addition of “.1”. Impeller 23.1 is substantially the same as impeller 23 shown in FIGS. 1 to 5 with the following exceptions.

Impeller 23.1 is particularly suited for mixing primarily liquid substances. The impeller has ten vanes 30.1, 32.1, 34.1, 38.1, 40.1, 42.1, 52, 54, 56 and 58 in this example. Vanes 32.1 and 52, 34.1 and 54, 40.1 and 56, and 42.1 and 58 are paired and aligned on opposite sides of body 27.1, respectively. For example, this is shown by vanes 32.1 and 52 in FIG. 6. The vanes are paired for operating balance. Each of the vanes 32.1 and 52, 34.1 and 54, 40.1 and 56, and 42.1 and 58 is substantially similar in shape. Vanes 32.1, 34.1, 40.1 and 42.1 extend radially and axially outwards from top 28.1 of the body 27.1 relative to the axis of rotation, with their distal ends, as shown by distal end 50.1 for vane 34.1, facing towards the top 13 of the tank 11 shown in FIG. 1. These vanes thus promote upward movement of the liquid. The vanes angle upwards to the same degree in this example, with their distal ends aligning in a plane.

Referring to FIG. 7, vanes 52, 54, 56 and 58 extend radially and axially outwards from the bottom 29.1 of the body 27.1 relative to the axis of rotation, with their distal ends, as shown by distal end 59 for vane 58, facing towards the bottom 14 of the tank 11 shown in FIG. 1. These vanes thus promote downward movement of the liquid. The vanes angle downwards to the same degree in this example, with their distal ends aligning in a plane.

Each vane is longitudinally curved and is channel-shaped. Vanes 32.1, 34.1, 40.1, 42.1, 52, 54, 56, and 58 have quadrilateral-shaped tops, quadrilateral-shaped bottoms, and curved sides, as shown by vane 52 in FIG. 6 having top 68, bottom 70, and side 66. The tops of vanes 32.1, 50.1, 40.1, and 42.1, which are spaced-apart from the top 28.1 of body 27.1, are concave-shaped in the direction facing the top 13 of the tank 11 seen in FIG. 1 and their corresponding bottoms are convex-shaped in the direction facing the bottom 14 of the tank. The tops of vanes 52, 54, 56 and 58, which are spaced-apart from the bottom 29.1 of body 27.1, are convex-shaped in the direction facing the top of the tank and their corresponding bottoms are concave-shaped in the direction facing the bottom of the tank.

Vanes 30.1 and 38.1 have quadrilateral-shaped tops, quadrilateral-shaped bottoms, and curved sides, as shown by vane 30.1 in FIG. 6 having top 62, bottom 64, and side 60.

The tops and the bottoms of the outer vanes 30.1, 32.1, 34.1, 38.1, 40.1, 42.1, 52, 54, 56, and 58 are tapered towards their distal ends 50.1. Each of the sides 60 and 66 of the vanes 30.1, 32.1, 34.1, 38.1, 40.1, 42.1, 52, 54, 56, and 58 extends in a vertical and generally perpendicular direction relative to the body 27.1 of the impeller 23.1. Each of the sides has an inner surface facing its top and bottom, and an outer surface facing away from its top and bottom, as shown by inner surface 67 and outer surface 69 for vane 30.1 in FIGS. 6 and 8. The sides 60 and 66 are longitudinally curved, with their inner surfaces 67 being longitudinally convex and their outer surfaces 69 being longitudinally concave in this example

Body 27.1 is annular and has a central aperture 85. Impeller 23.1 has a plurality of inner vanes, for example inner vane 87, connected to the top 28.1 of the body 27.1, in this example. The inner vanes have proximal ends connected to the hub and circumferentially-spaced-apart distal ends. This is shown in FIG. 8 for vane 87 with its proximal end 83 and distal end 84. The proximal ends of the vanes are positioned above the distal ends of the vanes, with the proximal ends being spaced-apart above the top 28.1 of body 27.1. Thus vanes 87 angle upwards from their distal ends 84 to their proximal ends 83. The inner vanes are quadrilaterals in shape in this example, with the distal ends of the vanes being larger than their proximal ends. The inner vanes 87 are connected to hub 24.1 to position the hub in place such that the hub is co-axial with aperture 85. The inner vanes 87 extend radially outwards from the hub. The inner vanes are angled upwards relative to the top 28.1 of the body. The inner vanes 87 are shaped to promote upward movement of liquid from the bottom 15 of the tank, through aperture 85, and towards the top 13 of the tank 11 shown in FIG. 1. This is shown by arrow of numeral 81 in FIG. 9. The inner vanes may thus inhibit solids within the tank from settling at the tank's bottom.

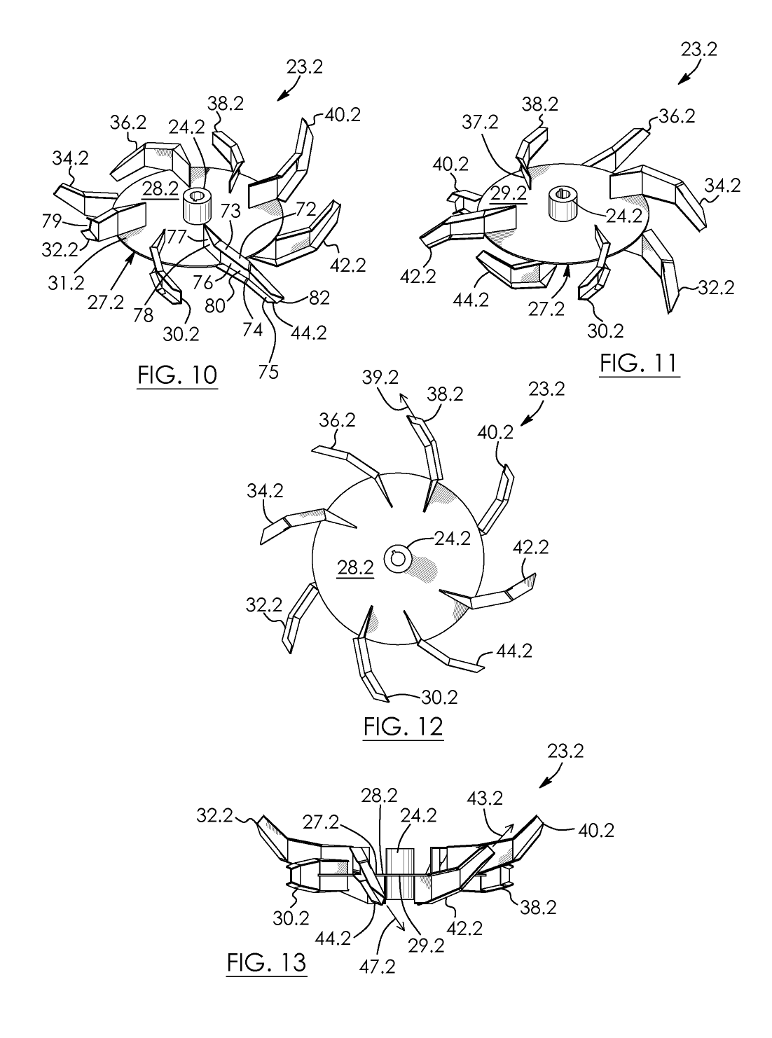

FIGS. 10 to 13 show an impeller 23.2 for the agitator assembly 10 shown in FIGS. 1 to 5 according to a third aspect. Like parts have like numbers and functionings as the embodiment shown in FIGS. 1 to 5 with the addition of “.2”. Impeller 23.2 is substantially the same as impeller 23 shown in FIGS. 1 to 5 with the following exceptions.

Each vane, for example vane 44.2 in FIG. 10, has a top 72 in the form of a plurality of quadrilateral-shaped, angularly spaced-apart plates 73, in this example, aligned at least partially parallel with top 28.2 of the body, a bottom 74 in the form of a plurality of quadrilateral-shaped, angularly spaced-apart plates 75, in this example, aligned at least partially parallel with bottom 29.2 of the body as shown in FIG. 11, and a side 76 in the form of a plurality of quadrilateral-shaped, angularly spaced-apart plates 77 aligned perpendicular to the body 27.2. The channel-shaped vanes, in cross-section, form a trapezoidal space for receiving and directing liquid therethrough. This is shown by space 79 for vane 32.2 in FIG. 10. Each vane, as shown by vane 44.2 in FIG. 10, is formed by a plurality of segments including a first segment 78 connected to the body 27.2, a second segment 80 connecting to and angled relative to its first segment, and a third segment 82 connecting to and angled relative to its second segment. The first segments are partially rectangular in shape in this example and the second and third segments are trapezoidal in shape in this example. Each of the vanes 30.2, 32.2, 34.2, 36.2, 38.2, 40.2, 42.2 and 44.2 has segments 78, 80, and 82 that are connected together in a generally curved manner.

As seen in FIG. 10, vanes 32.2, 36.2, 40.2 and 44.2 are connected to and extend from the top 28.2 of the body 27.2. As seen in FIG. 11, vanes 34.2 and 42.2 are connected to and extend from the bottom 29.2 of the body. Referring to FIG. 10, vanes 32.2, 34.2, 40.2, and 42.2 extend upwards towards the top of the tank, for directing liquid in the upward direction. As shown in FIG. 11, vanes 36.2 and 44.2 extend downwards towards the bottom of the tank, for directing liquid in the downward direction.

As seen in FIG. 13, vanes 30.2 and 38.2 are connected to both the top 28.2 and bottom 29.2 of the body 27.2, with the body bisecting the proximal ends of these vanes. Vanes 30.2 and 38.2 are shaped to extend radially outwards and their segments are generally tangentially curved.

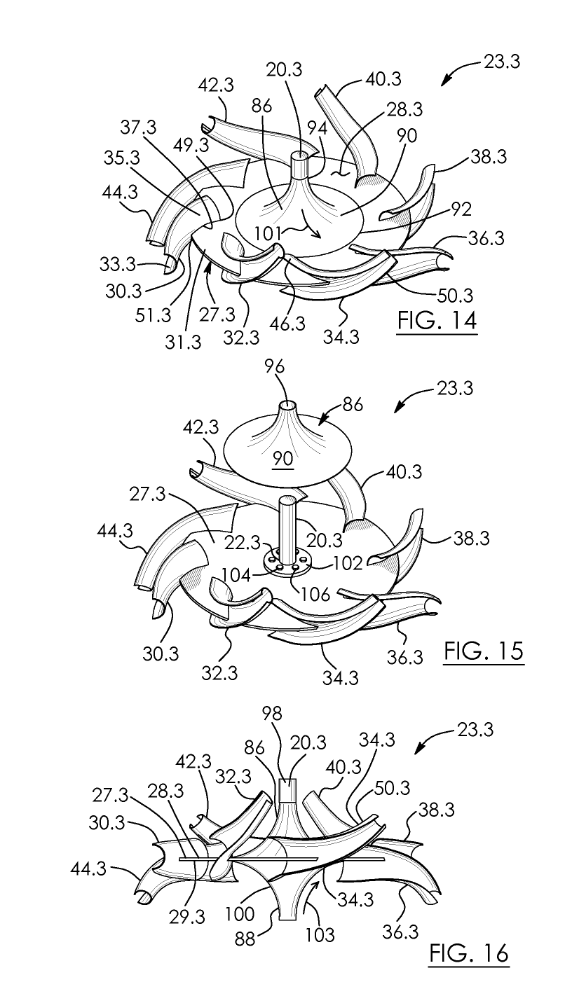

FIGS. 14 to 16 show an impeller 23.3 for the agitator assembly 10 shown in FIGS. 1 to 5 according to a fourth aspect. Like parts have like numbers and functionings as the embodiment shown in FIGS. 1 to 5 with the addition of “.3”. Impeller 23.3 is substantially the same as impeller 23 shown in FIGS. 1 to 5 with the following exceptions.

Referring to FIGS. 14 and 16, the impeller has a pair of centrally disposed deflectors 86 and 88, mounted to the top 28.3 and bottom 29.3 of body 27.3, respectively. Each deflector is substantially the same as the other and therefore only deflector 86 will be described in detail. As seen in FIG. 15, deflector 86 is generally conical in shape and, in particular, has a concave frustoconical outer surface 90 in this example. Referring to FIG. 14, the deflector's proximal end 92 abuts top 28.3 of body 27.3, and is larger in radius relative to its distal end 94, which is axially spaced-apart from the top 28.3 of the body of the impeller 23.3, axially in the direction of the axis of rotation of the impeller 23.3. As seen in FIG. 15, the deflector 86 has a central aperture 96 extending from end 92 to end 94 and shaped to receive agitator shaft 20.3, as shown in FIG. 14, with the deflector snugly receiving the shaft at end 92 of the deflector.

Referring to FIGS. 14 and 16, the deflector 86 is curved and continuous in profile and provides a smooth path for the liquid to be agitated to pass therealong from the top 28.3 of the body 27.3, along the surface 90 and to the outer surface 98 of the shaft 20.3. In a like manner and referring to FIG. 16, deflector 88 is also curved in profile and provides a smooth path in profile between the bottom 29.3 of the body and the deflector's corresponding concave, conical surface 100.

Deflector 86 is shaped to direct liquid in an axially downward and radially outward direction, as shown by arrow of numeral 101 in FIG. 14. Put another way, deflector 86 is shaped to direct liquid downward and outward towards portions of the proximal ends 46.3 of the vanes disposed above the body 27.3, driving the flow of liquid out through the distal ends 50.3 of the vanes. Referring to FIG. 16, deflector 88 is shaped to direct liquid an axially upward and radially outward direction, as shown by arrow of numeral 103, towards portions of the proximal ends of the vanes disposed below the body 27.3, driving the flow of liquid out through the distal ends of the vanes. The deflectors may be welded to the body 27.3 or frictionally engage with the shaft 20.3 for example.

As seen in FIG. 15, a flange 102 connects to the second end 22.3 of the shaft, by welding in this example. The flange has a plurality of circumferentially spaced-apart apertures 104. The body 27.3 has a plurality of corresponding apertures, and the flange 102 is centrally connectable to the top 28.3 of the body 27.3 of impeller 23.3 by way of a plurality of connectors passing through said apertures. In this example the connectors are in the form of bolts and nuts, as generally shown by numeral 106, though this is strictly not required. For example, the connectors may be in the form of rivets, for example, according to another embodiment.

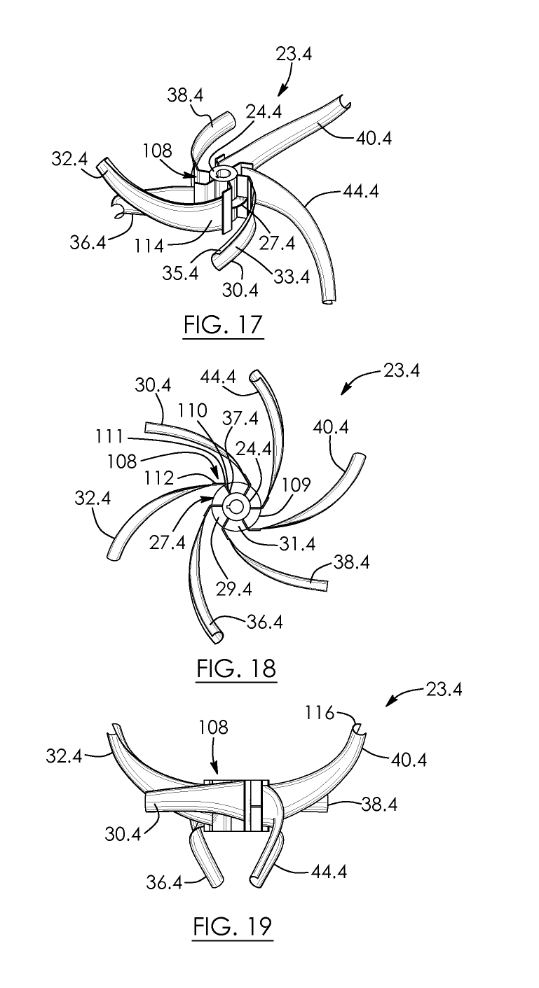

FIGS. 17 to 19 show an impeller 23.4 for the agitator assembly 10 shown in FIGS. 1 to 5 according to a fifth aspect. Like parts have like numbers and functionings as the embodiment shown in FIGS. 1 to 5 with the addition of “.4”. Impeller 23.4 is substantially the same as impeller 23 shown in FIGS. 1 to 5 with the following exceptions.

Impeller 23.4 has a plurality of circumferentially spaced-apart, vertically-aligned connector plates, as shown by plate 108 in FIG. 17, connected to and extending radially outwards from the hub 24.4. Body 27.4 is also centrally connected to and extends around hub 24.4. Referring to FIG. 18, each of the plates has a first portion 110 that extends through a respective one of the circumferentially spaced-apart slots 37.4 of the body, which are substantially straight in this example. Each of the plates 108 also has a second portion 112 that extends generally tangential to the circular outer edge 109 of the body 27.4. The second portions are bent relative to the first portions and both the first and second portions are generally rectangular in shape, in this example, and extend in a longitudinal, axial direction. The connector plates 108 may function to reinforce body 27.4 and impeller 23.4 generally and may also function to promote centrifugal movement of the liquid or other contents of the tank.

Body 27.4 is relatively small compared to the embodiments shown in FIGS. 1 to 16, with its outer edge 109 aligning adjacent to a position 111, seen in FIG. 18, where the first portions 110 and second portions 112 of the plate 108 connect, in this example.

Each of the outer vanes 30.4, 32.4, 36.4, 38.4, 40.4 and 44.4 has a proximal end that is flat, as shown by end 114 for vane 32.4 in FIG. 17. The second portions 112 of the connector plates 108 connect the proximal ends of the outer vanes to the body 27.4 in this example. This connection may be by way of welding, for example, though this is not strictly required and other ways of connecting the vanes to the connector plates are possible. Each of the outer vanes 30.4, 32.4, 36.4, 38.4, 40.4 and 44.4 has a distal end that is c-shaped in cross-section in this example, as seen in FIG. 19 by distal end 116 for vane 40.4. The vanes fully extend outwards from the body 27.4 and do not directly connect with the body in this example.

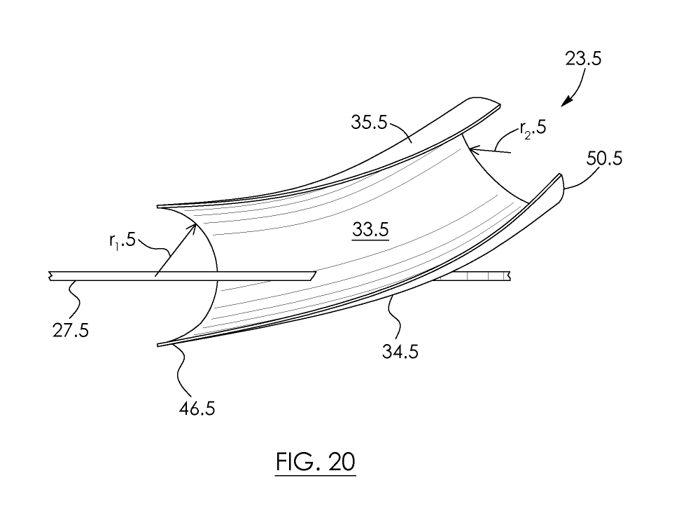

FIG. 20 shows part of an impeller 23.5 for the agitator assembly 10 shown in FIGS. 1 to 5 according to a sixth aspect. Like parts have like numbers and functionings as the embodiment shown in FIGS. 1 to 5 with the addition of “.5”. Impeller 23.5 is substantially the same as impeller 23 shown in FIGS. 1 to 5 with the exception that each of its outer vanes are non-tapered. Each of the vanes is substantially identical to those vanes shown in FIGS. 1 to 5 and therefore only vane 34.5 is shown and will be described. The proximal end 46.5 of vane 34.5 is substantially equal in size to distal end 50.5 of vane 34.5. The radius of curvature r₁.5 for each of the ends 46.5 of the vanes is also substantially equal in size to the radius of curvature r₂.5 of each of the ends 50.5 of the vanes.

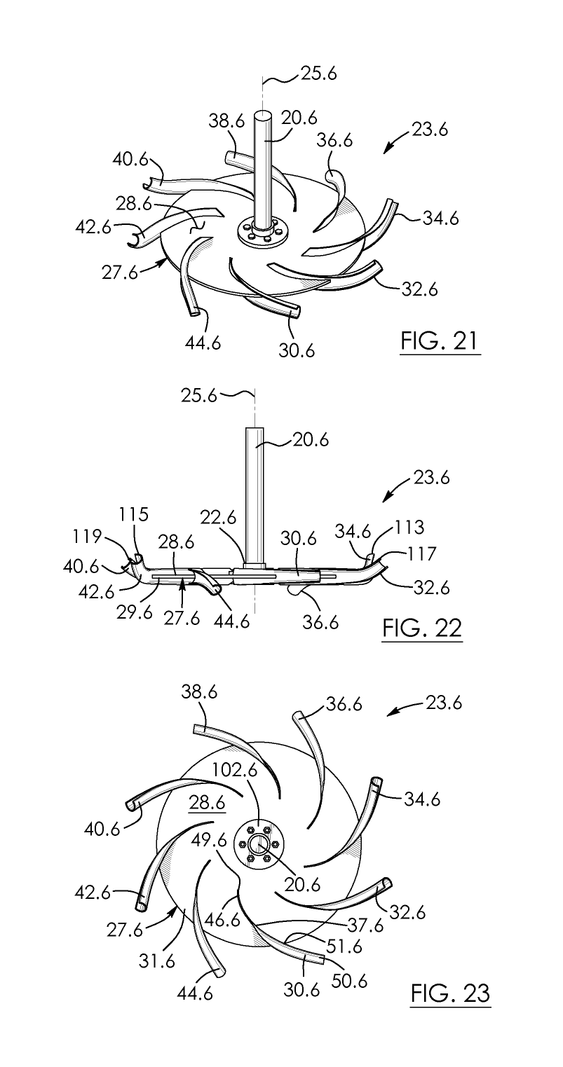

FIGS. 21 to 26 show an impeller 23.6 for the agitator assembly 10 shown in FIGS. 1 to 5 according to a seventh aspect. Like parts have like numbers and functionings as the embodiment shown in FIGS. 1 to 5 with the addition of “.6”. Impeller 23.6 is substantially the same as impeller 23 shown in FIGS. 1 to 5 with the following exceptions.

In this case and as seen in FIG. 23, the ends 49.6 of the slots 37.6 of the body are positioned adjacent to flange 102.6 and are interposed between shaft 20.6 and the outer peripheral portion 31.6 of body 27.6. As seen in FIG. 22, the distal ends 113 and 115 of vanes 34.6 and 42.6 are more axially spaced above body 27.6 further than the distal ends 117 and 119 of vanes 32.6 and 40.6 in this example, axially in the direction of axis 25.6.

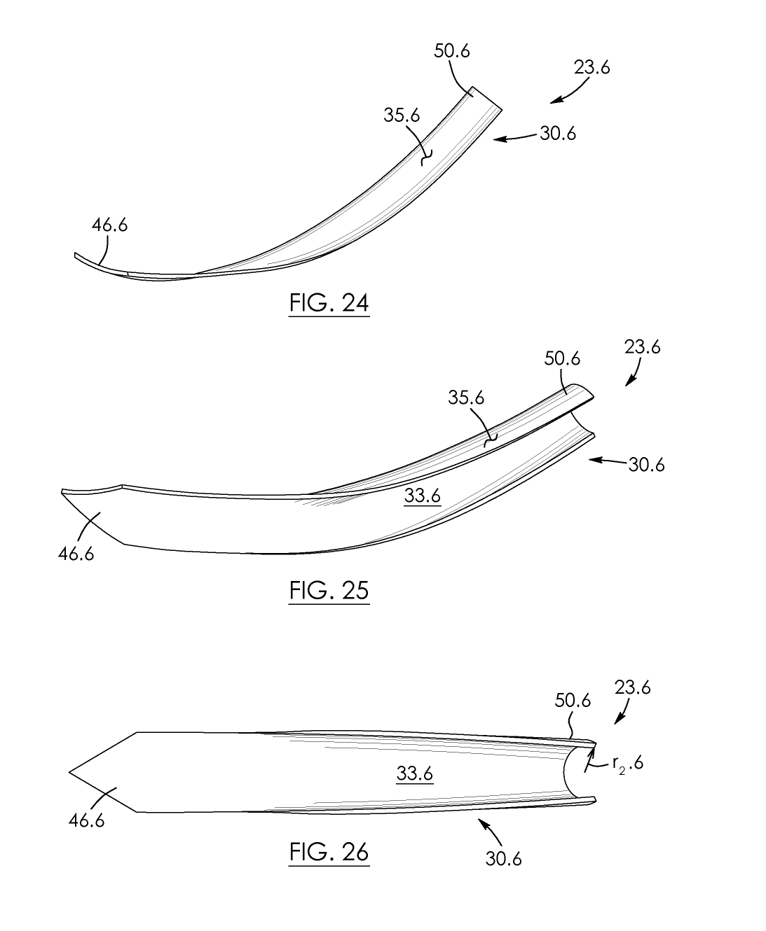

The proximal ends of the vanes are substantially flat and slightly concave shaped, as best seen by proximal end 46.6 of vane 30.6 in FIG. 24. The proximal ends of the vanes are substantially triangular in shape, with their pointed portions abutting the ends 49.6 of the slots 37.6 seen in FIG. 23. The proximal ends 46.6 of the vanes extend in a substantially vertical direction in this example. The proximal ends of the vanes are positioned substantially perpendicular to the top 28.6 and bottom 29.6 of the body 27.6, as seen with references to FIGS. 22, 23 and 26.

According to another variation, the impellers set out in FIGS. 1 to 20 may, alternatively, have vanes with proximal ends as set out for impeller 23.6.

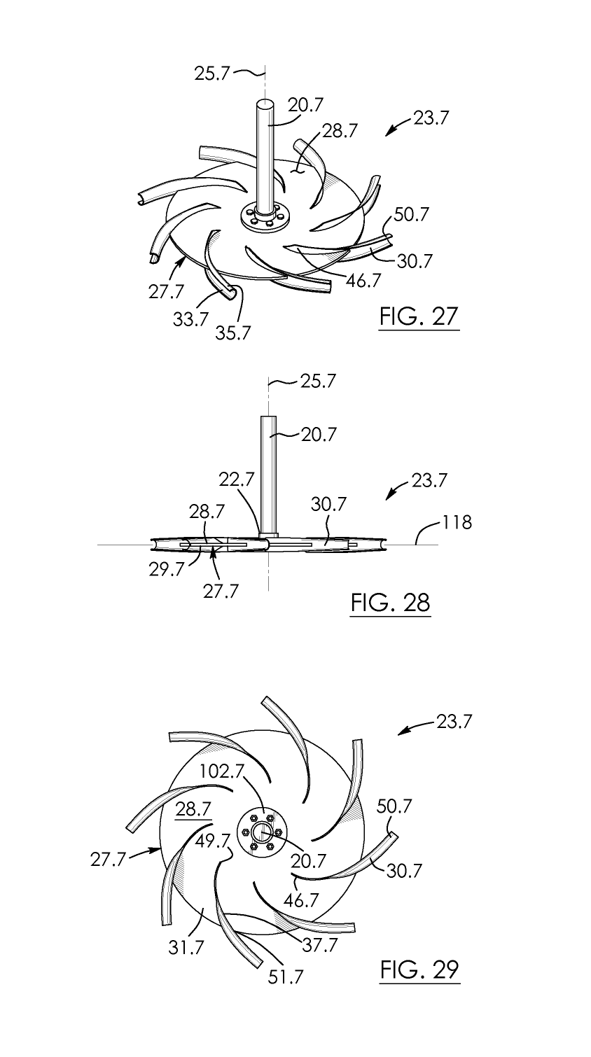

FIGS. 27 to 29 show an impeller 23.7 for the agitator assembly 10 shown in FIG. 1 according to an eighth aspect. Like parts have like numbers and functionings as the embodiment shown in FIGS. 21 to 26 with decimal extension “.7” replacing decimal extension “.6”. Impeller 23.7 is substantially the same as impeller 23.6 shown in FIGS. 21 to 26 with the exception that the vanes 30.7 substantially align together in a plane 118, seen in FIG. 28. The proximal ends 46.7 and distal ends 50.7 of the vanes 30.7 are aligned with the plane 118. Body 27.7 is also aligned with this plane, which is perpendicular to shaft 20.7. Each of the vanes extends in a substantially tangential direction in this example relative to body 27.7. The vanes also extend in a substantially horizontal direction.

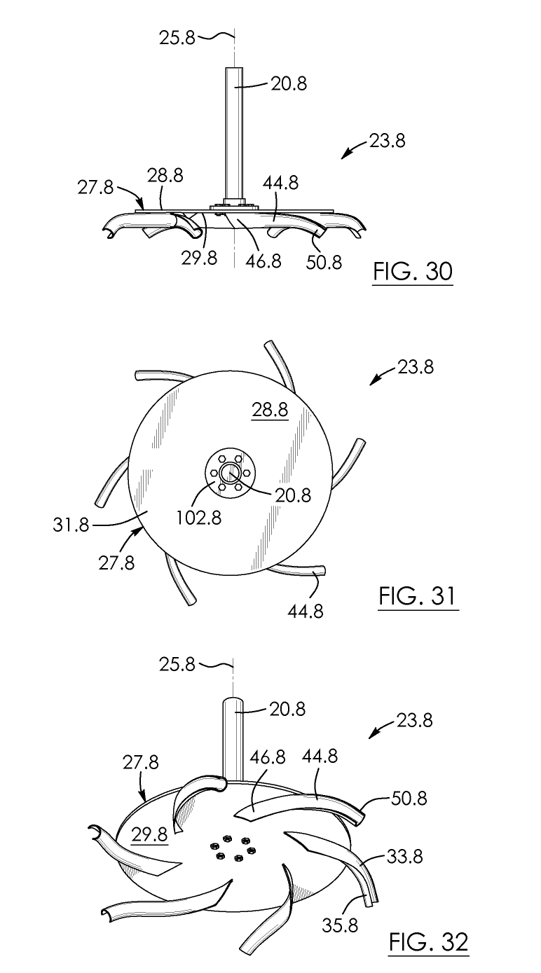

FIGS. 30 to 32 show an impeller 23.8 for the agitator assembly 10 shown in FIG. 1 according to a ninth aspect. Like parts have like numbers and functionings as the embodiment shown in FIGS. 21 to 26 with decimal extension “.8” replacing decimal extension “.6”. Impeller 23.8 is substantially the same as impeller 23.6 shown in FIGS. 21 to 26 with the following exceptions.

The vanes 44.8 may connect to and extend outwards from at least one of the top 28.8 and the bottom 29.8 of the body 27.8, and in this example the vanes connect to and extend outwards the bottom of the body. Also, the vanes extend downwards, with their distal ends 50.8, seen in FIG. 30, being axially spaced below the bottom 29.8 of body 27.8, axially referring to axis of rotation 25.8 seen in FIG. 30. The vanes may connect to the body via welding, according to one example, though this is strictly not required and other ways of connecting the vanes of the bottom of the body are possible according to other embodiments.

In another embodiment, the vanes may connect to the top of the body. In a further embodiment, the vanes may further all extend upwards.

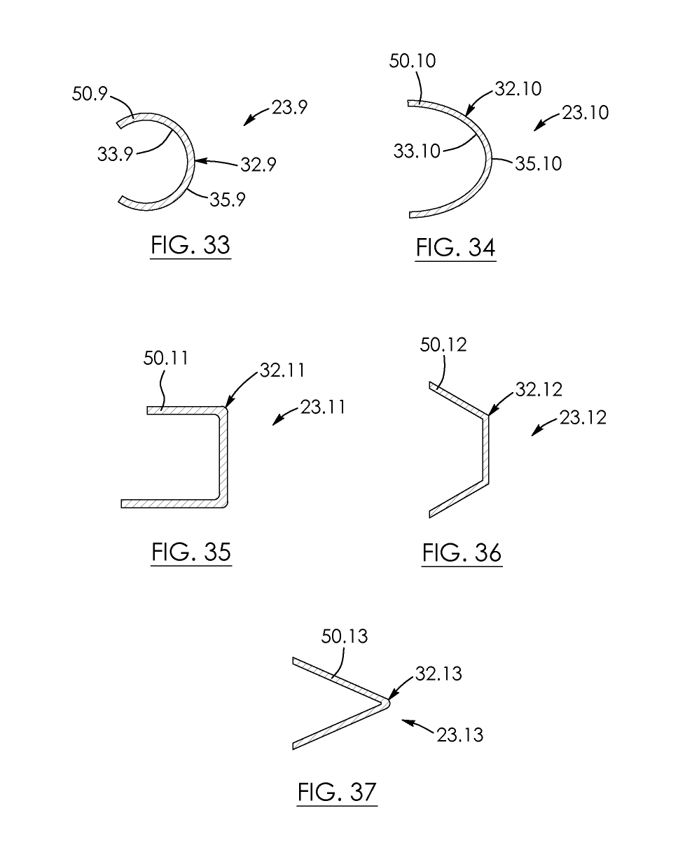

FIG. 33 shows the distal end 50.9 of one of the vanes 32.9 of an impeller 23.9 according to a tenth aspect. The impeller may be otherwise substantially the same as the impeller 23.1 shown in FIGS. 6 to 9 or impeller 23.2 shown in FIGS. 10 to 13. Like parts have like numbers and functionings with decimal extension “.9” replacing decimal extensions “.1” and “.2”, respectively, with the following exception. The distal ends 50.9 of the impellers 23 are c-shaped in cross-section.

FIG. 34 shows the distal end 50.10 of one of the vanes 32.10 of an impeller 23.10 according to an eleventh aspect. The impeller may be otherwise substantially the same as the impellers 23.1 to 23.8 shown in FIGS. 1 to 32. Like parts have like numbers and functionings with decimal extension “.10” replacing decimal extensions “.1” to “.8”, respectively, with the following exception. The distal ends 50.10 of the impellers 23 are semi oval-shaped in cross-section.

FIG. 35 shows the distal end 50.11 of one of the vanes 32.11 of an impeller 23.11 according to a twelfth aspect. The impeller may be otherwise substantially the same as the impellers 23.1 or 23.4 to 23.8 shown in FIGS. 1 5 and 14 to 32, respectively. Like parts have like numbers and functionings with decimal extension “.11” replacing decimal extensions “.1” and “.4” to “.8”, respectively, with the following exception. The distal ends 50.11 of the impellers 23 are u-shaped and at least partially square-shaped in cross-section.

FIG. 36 shows the distal end 50.12 of one of the vanes 32.12 of an impeller 23.12 according to a thirteenth aspect. The impeller may be otherwise substantially the same as the impellers 23.1 to 23.8 shown in FIGS. 1 to 32. Like parts have like numbers and functionings with decimal extension “.12” replacing decimal extensions “.1” to “.8”, respectively, with the following exception. The distal ends 50.12 of the impellers 23 are isosceles-trapezoid shaped in cross-section.

FIG. 37 shows the distal end 50.13 of one of the vanes 32.13 of an impeller 23.13 according to a fourteenth aspect. The impeller may be otherwise substantially the same as the impellers 23.1 to 23.8 shown in FIGS. 1 to 32. Like parts have like numbers and functionings with decimal extension “.13” replacing decimal extensions “.1” to “.8”, respectively, with the following exception. The distal ends 50.13 of the impellers 23 are v-shaped in cross-section. It will be appreciated that yet further variations are possible within the scope of the invention described herein. For example, as mentioned above, the number of vanes may vary. Also, the angular positioning of the outer vanes may vary. The vanes may connect at their proximal ends to the top, the bottom, or both the top and bottom of the body of the impeller. The vanes may be fully curved or partially curved. The vanes may be formed with a plurality of plates welded together. While many examples of specific shapes of the distal ends of the vanes have been provided, the impeller may have still further variations in shape.

It also will be understood by someone skilled in the art that many of the details provided above are by way of example only and are not intended to limit the scope of the invention which is to be determined with reference to the following claims.

What is claimed is:

1. A mixing impeller for an agitator, the impeller comprising:
a body; and
a plurality of circumferentially spaced-apart, longitudinally curved, at least partially channel-shaped outer vanes connected to and extending outwards from the body in a plurality of different directions.

2. The impeller as claimed in claim 1 wherein the body includes a plurality of circumferentially spaced-apart slots through which the vanes are received.

3. The impeller as claimed in claim 1 wherein the body is annular and has a plurality of arc-shaped slots for receiving the vanes and wherein the body intersects with and at least partially extends through the vanes.

4. The impeller as claimed in claim 1 wherein each vane has a proximal end connected to the body and a distal end which is radially and circumferentially spaced-apart from its proximal end.

5. The impeller as claimed in claim 1, the impeller having an axis of rotation and wherein each vane has a proximal end connected to the body and a distal end spaced-apart from its proximal end, at least one of the distal ends of the vanes being axially spaced-apart from the body.

6. The impeller as claimed in claim 1, the impeller having an axis of rotation and wherein each vane has a proximal end connected to the body and a distal end which is spaced-apart from its proximal end, the distal end of at least one of the vanes being axially spaced above the body and the distal end of at least another of the vanes being axially spaced below the body.

7. The impeller as claimed in claim 1 wherein the body has a top and a bottom opposite the top, and wherein the vanes connect to and extend outwards from at least one of the top and the bottom of the body.

8. The impeller as claimed in claim 1 wherein the body has a bottom and wherein the vanes connect to and extend outwards from the bottom of the body.

9. The impeller as claimed in claim 8 wherein the vanes extend downwards.

10. The impeller as claimed in claim 1, further including a centrally disposed deflector connected to the body, the deflector having a concave frustoconical outer surface, wherein the impeller has an axis of rotation, wherein the body has a top and a bottom opposite the top, the deflector connecting to the top of the body and being configured to direct liquid in an axially downward and radially outward direction relative to the axis of rotation, and wherein the impeller has a further deflector having a concave frustoconical outer surface, the further deflector connecting to the bottom of the body and being configured to direct liquid in an axially upward and radially outward direction relative to the axis of rotation.

11. The impeller as claimed in claim 1 wherein the vanes are substantially aligned in a plane.

12. The impeller as claimed in claim 1 wherein the vanes have proximal ends connected to the body, the proximal ends of the vanes being substantially flat.

13. The impeller as claimed in claim 1 wherein the vanes have proximal ends connected to the body, the proximal ends of the vanes being substantially perpendicular to the body.

14. The impeller as claimed in claim 1, wherein the vanes have proximal ends connected to the body, the proximal ends of the vanes being substantially triangular.

15. The impeller as claimed in claim 1, wherein the vanes have distal ends spaced-apart from the body, the distal ends of the vanes being c-shaped in cross-section.

16. The impeller as claimed in claim 1, wherein the vanes have distal ends spaced-apart from the body, the distal ends of the vanes being semi oval-shaped.

17. The impeller as claimed in claim 1, wherein the vanes have distal ends spaced-apart from the body, the distal ends of the vanes being u-shaped in cross-section.

18. The impeller as claimed in claim 1, wherein the vanes have distal ends spaced-apart from the body, the distal ends of the vanes being v-shaped in cross-section.

19. The impeller as claimed in claim 1, wherein the vanes have distal ends spaced-apart from the body, the distal ends of the vanes being isosceles-trapezoid shaped in cross-section.

20. In combination, an agitator having a housing, an actuator mounted to the housing, a shaft rotatably connected to the actuator and the impeller as claimed in claim 1, the impeller being rotatably mounted to the shaft.
